(19) United States
(12) Patent Application Publication
(10) Pub. No.: US 2014/0237077 A1
(43) Pub. Date: Aug. 21, 2014

(54) METHODS AND SYSTEMS FOR PROVIDING FILE DATA FOR VIDEO FILES

(71) Applicants: James Westland Cain, Berkshire (GB); Simon Darryl Rogers, (GB); Michael James Weaver, (GB)

(72) Inventors: James Westland Cain, Berkshire (GB); Simon Darryl Rogers, (GB); Michael James Weaver, (GB)

(73) Assignee: Quantel Limited, Berkshire (GB)

(21) Appl. No.: 14/236,844

(22) PCT Filed: Jul. 26, 2012
(86) PCT No.: PCT/GB2012/051807

§ 371 Date: May 2, 2014

(30) Foreign Application Priority Data
Aug. 5, 2011 (GB) 1113621.5
Aug. 23, 2011 (GB) 1114628.9

(51) Int. Cl. H04L 29/06

(52) U.S. Cl. CPC H04L 65/60
USPC 709/217

(57) ABSTRACT

A method of providing file data for a converted video file from a file system. After receiving a request for a portion of file data from the converted video file, an existing video file from which to derive the file data is determined. A portion of file data from the existing file that corresponds to the requested portion of file data is then determined, and file data from the portion of file data from the existing file data, by converting the portion of file data to file data of a different quality. The generated file data is then returned.

### FIELD OF THE INVENTION

The present invention concerns methods and systems for providing file data for video files; that is, files containing video data. More particularly, but not exclusively, the invention concerns improved methods and systems for providing file data for video files, that can be used with existing video applications and systems.

### BACKGROUND OF THE INVENTION

It is common for systems which manipulate video files, for example systems that stream video over the Internet or video editing applications, to require video file data at a different quality than the quality in which it is originally provided.

For example, a video streaming system may vary the quality of video data it streams dependent on the bandwidth available for transferring the video data. This allows higher-quality video to be sent when sufficient bandwidth is available, but lower-quality video can be sent when the bandwidth available is limited. A known example of this is the Internet Information Services (IIS) web server (as developed by Microsoft), when streaming video using the Smooth Streaming video service. FIG. 1 is a schematic diagram of a known system incorporating an IIS web server. A file system 1 comprises a data store 2, a file record database 3, and a file system gateway 4. The file system gateway 4 is in communication with an IIS web server 5. The IIS web server 5 communicates via the Internet 6 with a personal computer 7 running a video streaming client application 8, in this case a Silverlight application. The IIS web server 5 streams video to the client application 8 using the Smooth Streaming video service.

As is well known, the Smooth Streaming media service provides video in the form of fragmented MPEG-4 files at a quality level appropriate to the bandwidth over which the video is streamed. In essence, video is requested by the client application 8 at the highest quality the bandwidth it has available can support. (Higher quality video will be larger in size, and so will require greater bandwidth.) The client application 8 receives video from the IIS web server 5, which it stores in a buffer. When the buffer contains a sufficient duration of video (i.e. a number of seconds of video), the client application 8 begin to display the video. If the client application 8 finds that the duration of video in the buffer has increased beyond a certain point, this indicates that additional bandwidth is available, and so the client application 8 increases the quality of the video it requests. Conversely, if the amount of video in the buffer falls beyond a certain point, this indicates that insufficient bandwidth is available, and so the client application 8 lowers the quality of the video it requests. In order to provide the differing qualities of video to the client application 8, the IIS web server 5 requires that files are available that provide versions of the video being streamed in all the quality levels that may be required, so that it can provide them as and when requested by the client application 8.

FIG. 2 shows a typical use of files of differing qualities by an IIS web server 5 using Smooth Streaming. The IIS web server 5 has files 21 to 25 of qualities 150 Kb/s, 300 Kb/s, 600 Kb/s, 900 Kb/s and 2000 Kb/s respectively. Initially, the client application 8 requests video of quality 150 Kb/s from file 1. When a certain duration of video has been obtained, display of the video will begin. The buffer then continues to receive video from the file 1. As the bandwidth required by this low-quality video is small, the duration of video in the buffer quickly increases (as video is being received at a faster rate than it is being displayed), and once it exceeds a certain point the client application 8 requests the next-highest quality video of quality 300 Kb/s from file 22. This continues as the buffer continues to fill, with at appropriate points the client application 8 requesting video at higher and higher qualities. The duration of the video in the buffer may also fall below a certain point, for example due to a restriction in bandwidth, or because a change in the content of the video causes the same duration of video of the same quality of video to be larger in size. In this case, the client application 8 requests a lower quality of video. An example of this can be seen in FIG. 2 where the client application 8 is initially requesting the video of quality 2000 Kb/s from file 25, when the duration of video in the buffer falls below a certain point changes to requesting the video of lower quality 900 Kb/s from file 24, and then once the duration of video in the buffer has increased again returns to requesting the video of quality 2000 Kb/s from file 25.

Thus, conventionally in such a system an original video file in the highest quality required will be provided. This original video file is used to create the video files of each of the other qualities that may be streamed by the system. File data from the generated files (and also the original file) is streamed as and when required.

It is a disadvantage of such a system that the original video file is converted into the other quality files at the initial stage, i.e. before streaming begins. In the common scenario of a web site serving a single video to multiple users (over time and/or at the same time), the overhead of creating the files in advance is not great. This is because there are few files to serve to many recipients. However, in scenarios in which there are many files that may be served to a small number of recipients, the overhead of generating the required files in advance can become extremely significant, and may be overly onerous or even impracticable. An example of this would be where the file system 1 is an archive containing many video files. In this case, files of each required quality would need to be generated for every single file in the archive, even though any particular file may not be viewed at all. (A partial solution to this would be to create the files of differing quality only when a particular file is selected to be viewed, but this would cause a large delay before viewing of a selected file could begin.) Further, there may simply not be sufficient space to store all the required files.

To give another example of a system which requires video file data at a different quality than the quality at which it is originally provided, a user may wish to edit a video file of a particular quality using a video editing application. However, in order to reduce the amount of data that needs to be manipulated by the video editing application (during the editing process, at least), the video editing application itself may display lower quality video data than the video data that is actually being edited. To enable this, a lower quality file is generated from the original video file prior to the beginning of the editing process.

As with the previous example, a disadvantage is that the original video file is converted into the lower quality file at the initial stage, i.e. before editing begins.

The present invention seeks to solve and/or mitigate the above-mentioned problems. Alternatively or additionally, the present invention seeks to provide improved method and systems for providing file data for video files that can be used with existing video applications and systems.

### SUMMARY OF THE INVENTION

In accordance with a first aspect of the invention there is provided method of providing file data for a converted video file from a file system, the method comprising the steps of:

a) receiving a request for a portion of file data from the converted video file;

b) determining an existing video file from which to derive the file data;

c) determining a portion of file data from the existing file that corresponds to the requested portion of file data;

d) generating file data from the portion of file data from the existing file data, by converting the portion of file data to file data of a different quality; and

e) returning the generated file data.

By only generating the portion of file data when it is explicitly requested, the present invention advantageously does not require that the entire file be generated and stored in advance of the file data it is comprised of being required. This is advantageous as it means that space in the file system is not required in order to store the file, and further the processing overhead of generating the file does not need to be undertaken. This is particularly advantageous in cases in which it is not known which portions of file data from the file will be requested, and certain portions may not be requested at all. It is also particularly advantageous in cases where there are a large number of files which may or may not be requested, as the overhead associated with generating the files in advance (in terms of both processing and storage space) is avoided. Nevertheless, as only a particular portion is generated on request, and not the entire file containing the portion, the delay that would be associated with generating an entire file on the first occasion that a portion of it is requested is also avoided.

The quality may be bit-rate, frame-rate, resolution, frame size, or any other type of video quality.

The existing video file may be of the same format as the converted video file. Alternatively, the existing video file may be of a different file format.

Advantageously, the method further comprises the step of determining the desired properties of the converted video file, wherein the desired properties include the quality of the converted file data. The desired properties for the file may be derived from the structure of the request for the file, including the file name, for example. In this case (or indeed in other embodiments), all generated file data is of the same quality. Alternatively, portions of converted file data requested at different times may be of different qualities.

The format of the converted video file may require that the file comprises a plurality of segments of file data located at pre-declared locations within the file. The format may be MPEG-4, fragmented MPEG-4, or any other video file format. Each segment of file data in the file may correspond to a section of video of a pre-determined time duration. Advantageously, the method further comprises the steps of:

based on the desired properties of the file, determining a maximum segment length for the file;

in response to a request for the location of a segment within the file, returning a location calculated by considering each segment of the file to have the maximum segment length. This gives a pre-determined location for each segment of file data, without requiring the file data itself to be generated. The padding data may be instructions used in the format of the file to denote padding. Alternatively the padding may be blank data, for example a string of zeros. Advantageously the file data for a segment comprises file data derived from the existing file data and padding data to give the segment file data the maximum segment length. This has the particular advantage that the properties of the file data provided by the file system are in accordance with the format of the file being requested, and so the method can be used with existing video applications and system that expect the file being requested to have been fully generated and stored in advance. Preferably, the further comprises the step of, in response to a request to open the file, generating an index for the locations of the segments in the file. The file may comprises the index. Alternatively, the index may be provided as a separate file. Preferably, the padding data is dynamically generated and sent by the file system as the file data from the file that corresponds to padding data is requested.

In accordance with a second aspect of the invention there is provided a file system for providing file data for a converted video file, wherein the file system is arranged:

a) to receive a request for a portion of file data from the converted video file;

b) to determine an existing video file from which to derive the file data;

c) to generate file data from the portion of file data from the existing file data, by converting the portion of file data to file data of a different quality; and

e) to return the generated file data.

Advantageously, the file system is further arranged to determine the desired properties of the converted video file, wherein the desired properties include the quality of the converted file data.

The format of the file may require that the file comprise a plurality of segments of file data located at pre-declared locations within the file. Each segment of file data in the file may correspond to a section of video of a pre-determined time duration. Advantageously, the file system is further arranged to determine a maximum segment length for the file based on the desired properties of the file, and in response to a request for the location of a segment within the file, to return a location calculated by considering each segment of the file to have the maximum segment length. Advantageously, the file data for a segment comprises file data derived from the existing file data and padding data to give the segment file data the maximum segment length. Preferably, the file system is further arranged, in response to a request to open the file, to generate an index for the locations of the segments in the file. The file may comprise the index. Preferably, the padding data is dynamically generated and sent by the file system as the file data from the file that corresponds to padding data is requested.

In accordance with a third aspect of the invention there is provided a computer program product arranged, when executed, to perform the steps of any of the methods described above.

In accordance with a fourth aspect of the invention there is provided a computer program product arranged, when executed on a computing device, to provide a file system as described above.

It will of course be appreciated that features described in relation to one aspect of the present invention may be incorporated into other aspects of the present invention. For example, the method of the invention may incorporate any of the features described with reference to the apparatus of the invention and vice versa.

While the present invention is particularly advantageous for embodiments where it is expected that the requested file will be generated in advance, for example an embodiment where files are being provided to an IIS server sending files to a client application using the Smooth Streaming media service, the skilled person will appreciate that it is equally suited to any other video application or system that requests portions of video file data of differing qualities (or indeed video file data of a single quality that differs from the quality of the original video file).

### DESCRIPTION OF THE DRAWINGS

Embodiments of the present invention will now be described by way of example only with reference to the accompanying schematic drawings of which:

FIG. 1 is a diagram of a known networked computer system running the Smooth Streaming media service;

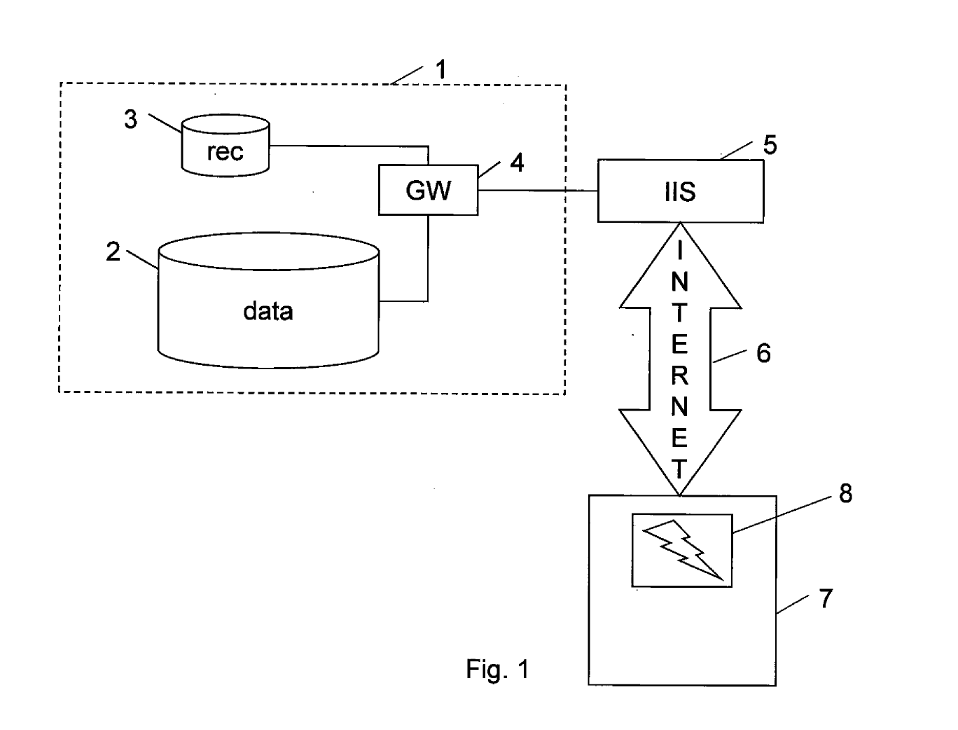

FIG. 2 shows the use of files by the system of FIG. 1;

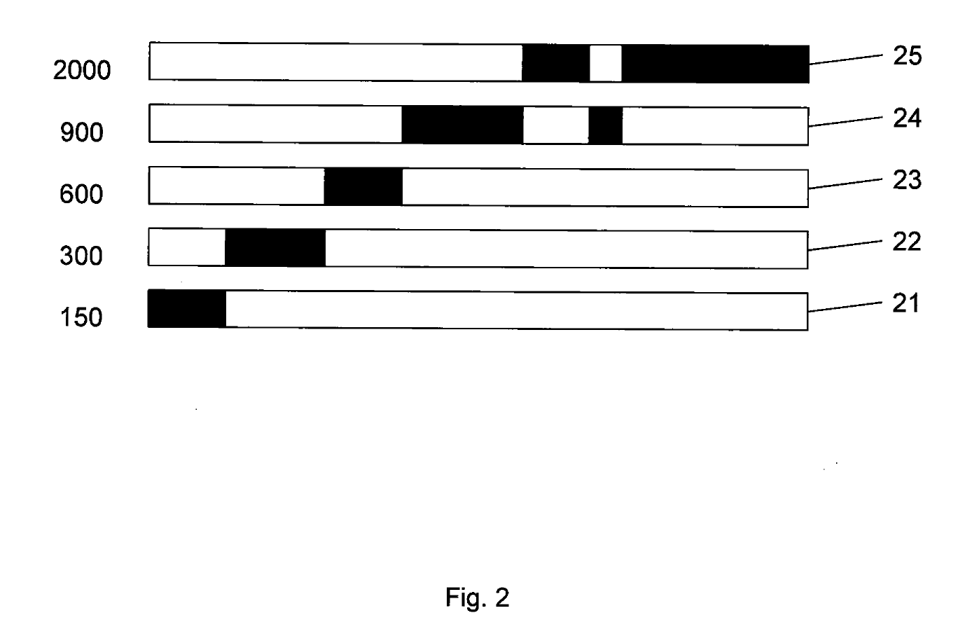

FIG. 3 is a diagram of a file system in accordance with a first embodiment of the present invention;

FIG. 4 shows the structure of a conventional MPEG-4 file;

FIG. 5 is a flow chart showing the operation of the system of the first embodiment in response to a request to open a file;

FIG. 6 shows the structure of an MPEG-4 file in accordance with the first embodiment;

FIG. 7 is a flow chart showing the operation of the system of the first embodiment in response to a request for file data.

### DETAILED DESCRIPTION

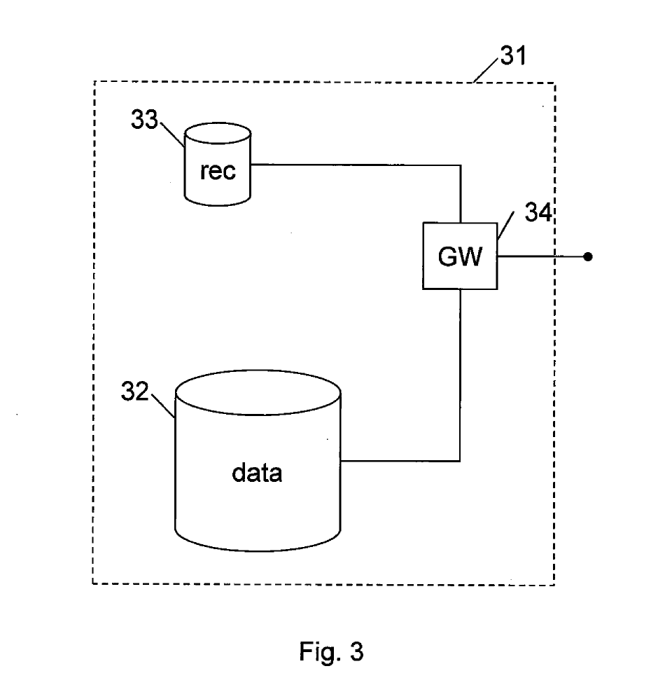

A file system in accordance with a first embodiment of the invention is shown in FIG. 3. The file system 31 comprises a data store 32, a file record database 33, and a file system gateway 34. The file system 31 is in the present embodiment used to provide on request video file data making up a MPEG-4 file, which is an MPEG-4 file containing video data of a particular quality, derived from higher quality video data in an original MPEG-4 file already stored in the file system 31. (In the following the new MPEG-4 file is referred to as the “converted” MPEG-4 file.)

However, the skilled person will appreciate that the file system 31 could equally be used to provide video file data in other formats, and to provide video data based on original video files in other formats, and based on original video files originating from outside the file system 31.

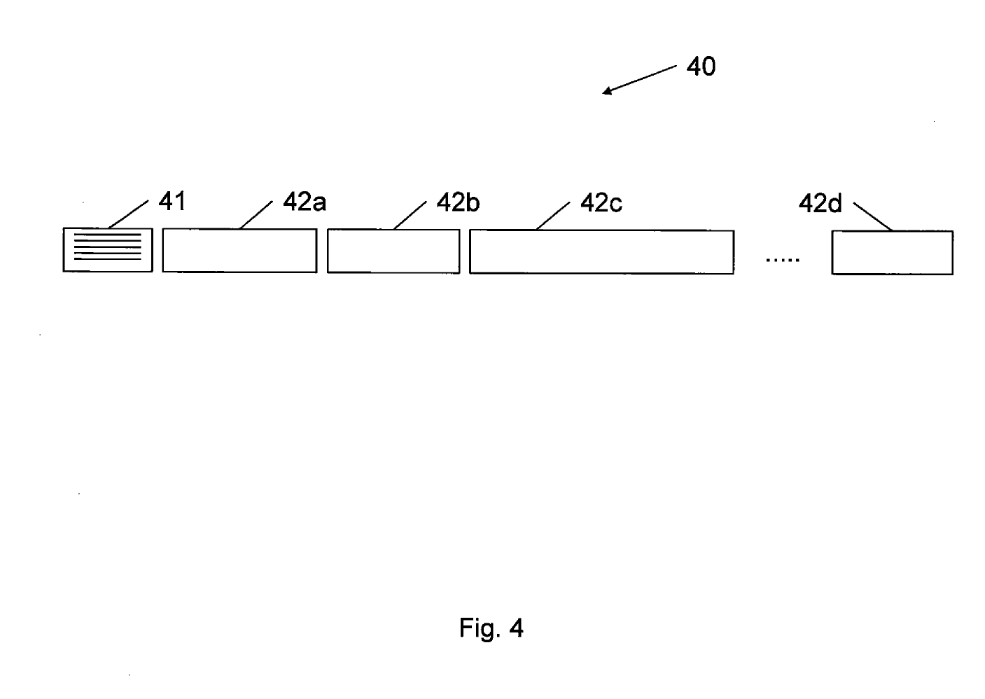

The original MPEG-4 file is a conventional MPEG-4 file, the structure of which is shown in FIG. 4. The file 40 comprises an index 41, and a plurality of segments 42a, 42b, 42c to 42d known as GOPs (“groups of pictures”). A GOP is a series of images making up a particular sequence of video. The images are compressed, and as can be seen from FIG. 4 this results in the GOPs being of different lengths (i.e. being made up of a different number of bytes). One reason for this is that the video a GOP represents will compress to a different size depending on the nature of the images making up the video; for example, as compression techniques include identifying the differences between images in a series, a series of very similar images will generally be compressed to a much smaller size than a series of images in which differ substantially from each other. The location of a GOP in a file will therefore depend on the size of each preceding GOP. The index 41 provides a mapping from time ranges of video to byte ranges in the file 40, thus allowing the GOP (or GOPs) corresponding to a particular time range of video to be found.

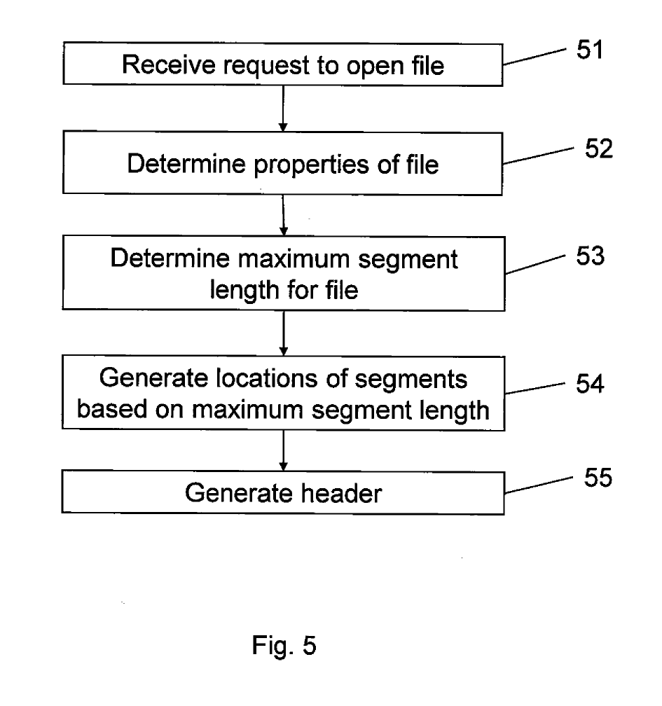

A request for file data from the converted MPEG-4 file will initially begin with a request to open the converted MPEG-4 file, and to read its index. Unlike the known systems described above, the file system 31 does not already contain the converted MPEG-4 file, generated in advance from the original MPEG-4 file. Instead, the operation of the file system 31 in response to a request to open the converted MPEG-4 file is as shown in FIG. 5.

First, a request to open the converted MPEG-4 file is received (step 51). The file system 31 determines the required properties for the converted MPEG-4 file (step 52), including the quality of video it should provide. This may be determined, for example, from the file name of the requested file, or its expected location in the file system 31.

The file system 31 then determines a maximum segment length (step 53) for the converted MPEG-4 file. This is based upon the maximum possible size of a GOP, which is calculated by assuming the GOP is made up of a particular number of images (for example 15 images), and then assuming the minimum possible compression for the images making up the GOP. In one particularly advantageous embodiment, the determination of the maximum possible GOP size is done by assuming that no inter-frame compression is done in the GOP. In practice, this means assuming that each image in the GOP is an I-frame, which is an image the encoding of which does not depend on the encoding of any other images in the GOP. I-frames contrast with P-frames, B-frames and D-frames, which are images encoded using information on how they differ from other images in the GOP. P-frames, B-frames and D-frames are used to provide a higher level of compression, and are particularly effective in cases where images in a GOP identical or very similar.

Once the maximum possible GOP size has been calculated, the maximum segment length is then determined to be at least that maximum possible size. The maximum segment length need not be taken to be exactly the same as the maximum GOP size; rather, the maximum GOP size gives a preferable minimum for the maximum segment length.

A location for each GOP within the file is then calculated, by assuming that each GOP has the maximum segment length (step 54). The index file will take up an initial range of bytes, with the first GOP being located immediately after the end of the index file. Each subsequent GOP is then located after the end of the preceding GOP, which is assumed to have the maximum segment length. The calculated locations are then used to generate the index for the file (step 55), which can be returned.

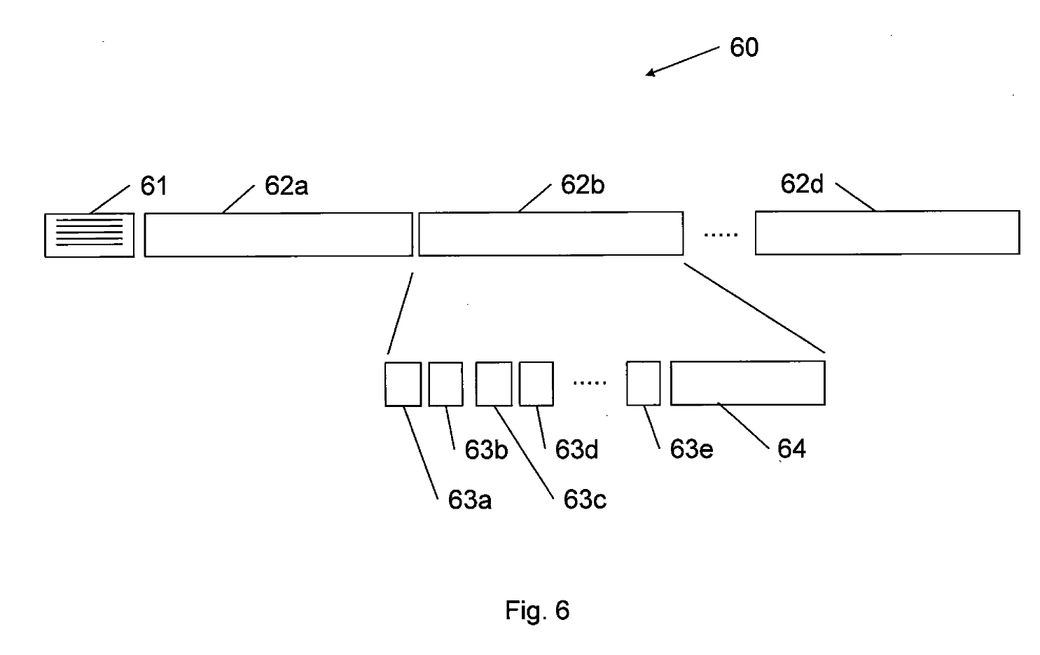

FIG. 6 shows the structure of the file described by the calculated locations (though the file itself has not in fact been generated). The file 60 begins with the index 61. There then follow GOPs 62a, 62b to 62d. As can be seen from FIG. 6, each GOP is of the same length, namely the maximum segment length.

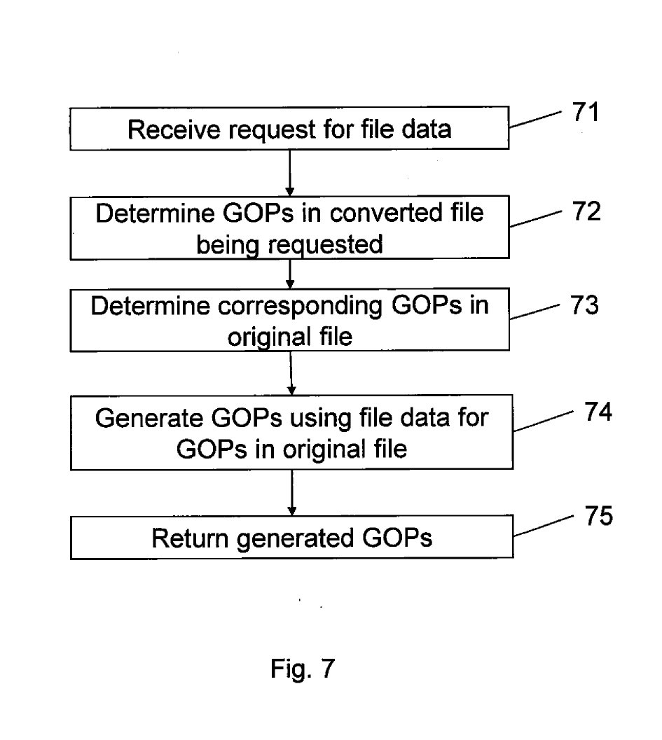

The operation of the file system 31 in response to a request for file data from the converted MPEG-4 file is now described with reference to FIG. 7. First, a request for file data from the converted MPEG-4 file is received (step 71). This will be a request for file data in a certain byte range. Using the calculated locations for the GOPs as recorded in the index 61, the file system 31 determines which GOPs are being requested (step 72), and the time range of video to which this corresponds.

The file system 31 then uses the index 41 of the original MPEG-4 file to determine the GOPs of the original MPEG-4 file which correspond to the time range of data being requested (step 73). The file data for these GOPs is then used to generate file data for the converted MPEG-4 file, by converting it to the quality required (as determined when the file was opened) (step 74).

It will be appreciated, however, that the GOPs generated from the original file data are unlikely to be of the maximum segment length, i.e. the length indicated by the index 61. To solve this, the end of a GOP is padded with blank data. The structure of the padded GOP is also shown in FIG. 6. The padded GOP comprises images 63a, 63b, 63c, 63d to 63e generated using the original file data, followed by padding 64, with the length of the padding 64 being such that the length of the moof matches the maximum segment length.

Finally, the file data for the padded GOPs is returned (step 75).

Thus, it can be seen that the file system 31 of the present embodiment is able to provide file data for only a portion the converted MPEG-4 file from the original MPEG-4 file, without requiring the entirety of the converted MPEG-4 file to be generated in advance. This is despite the fact that the file system 31 is obliged to declare in advance (via the index) the locations of all of the GOPs within the converted MPEG-4 file.

In an alternative embodiment of the invention, a file system similar to the file system of the previous embodiment provides on demand video data requested by an IIS server running the Smooth Streaming media service. In this embodiment, the requested video data is for files in the fragmented MPEG-4 format. In this embodiment, the operation of the file system in response to requests to open a file and to provide file data are similar to the previous embodiment, but adapted to the fragmented MPEG-4 format.

Whilst the present invention has been described and illustrated with reference to particular embodiments, it will be appreciated by those of ordinary skill in the art that the invention lends itself to many different variations not specifically illustrated herein.

The skilled person will appreciate that the invention is equally applicable to the provision of file data making up video files in formats other than MPEG-4 or fragmented MPEG-4. In particular, the skilled person will appreciate that the invention is equally applicable to file formats in which the location of data corresponding to particular time ranges does not need to be declared in (for example) and index file when the file is first opened.

1. A method of providing file data for a converted video file from a file system, the method comprising the steps of:
a) receiving a request for a portion of file data from the converted video file;
b) determining an existing video file from which to derive the file data;
c) determining a portion of file data from the existing file that corresponds to the requested portion of file data;
d) generating file data from the portion of file data from the existing file data, by converting the portion of file data to file data of a different quality; and
e) returning the generated file data.

2. A method as claimed in claim 1, further comprising the step of determining the desired properties of the converted video file, wherein the desired properties include the quality of the converted file data.

3. A method as claimed in claim 1, wherein the format of the converted video file requires that the file comprises a plurality of segments of file data located at pre-declared locations within the file.

4. A method as claimed in claim 3, wherein each segment of file data in the file corresponds to a section of video of a pre-determined time duration.

5. A method as claimed in claim 2, further comprising the steps of:
based on the desired properties of the file, determining a maximum segment length for the file;
in response to a request for the location of a segment within the file, returning a location calculated by considering each segment of the file to have the maximum segment length.

6. A method as claimed in claim 5, wherein the file data for a segment comprises file data derived from the existing file data and padding data to give the segment file data the maximum segment length.

7. A method as claimed in claim 3, further comprising the step of, in response to a request to open the file, generating an index for the locations of the segments in the file.

8. A method as claimed in claim 7, wherein the file comprises the index.

9. A method as claimed in claim 6, wherein the padding data is dynamically generated and sent by the file system as the file data from the file that corresponds to padding data is requested.

10. A file system for providing file data for a converted video file, wherein the file system is arranged:
a) to receive a request for a portion of file data from the converted video file;
b) to determine an existing video file from which to derive the file data;
c) to generate file data from the portion of file data from the existing file data, by converting the portion of file data to file data of a different quality; and
e) to return the generated file data.

11. A file system as claimed in claim 10, further arranged to determine the desired properties of the converted video file, wherein the desired properties include the quality of the converted file data.

12. A file system as claimed in claim 11, wherein the format of the file requires that the file comprise a plurality of segments of file data located at pre-declared locations within the file.

13. A file system as claimed in claim 12, wherein each segment of file data in the file corresponds to a section of video of a pre-determined time duration.

14. A file system as claimed in claim 11, further arranged to determine a maximum segment length for the file based on the desired properties of the file, and in response to a request for the location of a segment within the file, to return a location calculated by considering each segment of the file to have the maximum segment length.

15. A file system as claimed in claim 14, wherein the file data for a segment comprises file data derived from the existing file data and padding data to give the segment file data the maximum segment length.

16. A file system as claimed in claim 12, further arranged, in response to a request to open the file, to generate an index for the locations of the segments in the file.

17. A file system as claimed in claim 16, wherein the file comprises the index.

18. A file system as claimed in claim 15, wherein the padding data is dynamically generated and sent by the file system as the file data from the file that corresponds to padding data is requested.

19. A non-transitory computer program product arranged to provide file data for a converted video file, the computer program product including instructions which, when executed by a computing device, cause the computing device to:
a) receive a request for a portion of file data from the converted video file;
b) determine an existing video file from which to derive the file data;
c) generate file data from the portion of file data from the existing file data, by converting the portion of file data to file data of a different quality; and
e) return the generated file data.

20. (canceled)

21. A non-transitory computer program product as claim in claim 19, wherein the instructions, when executed by a computed device, cause the computing device to determine the desired properties of the converted video file, wherein the desired properties include the quality of the converted file data.
